(19) United States
(12) Patent Application Publication
(10) Pub. No.: US 2011/0231012 A1
(43) Pub. Date: Sep. 22, 2011

(54) APPARATUS, SYSTEM AND METHOD FOR ACCURATE DISPENSING OF PRESCRIPTION MEDICATIONS

(76) Inventors: Sara Sprague, Orlando, FL (US); George T. Simmons, III, Paradise Valley, AZ (US)

(21) Appl. No.: 13/047,531

(22) Filed: Mar. 14, 2011

Related U.S. Application Data
(60) Provisional application No. 61/314,522, filed on Mar. 16, 2010.

(51) Int. Cl. G06F 7/00

(52) U.S. Cl. 700/237

(57) ABSTRACT

An apparatus for the recording and dispensing of medication has an electronic device having a screen and a keyboard. A first input device is coupled to the electronic device to send data to the electronic device to verify a particular user of the electronic device. A dispensing device is coupled to the electronic device for dispensing medication to the particular user once the electronic device has verified the particular user.

### RELATED APPLICATIONS

The present application is related and claims the benefit of provisional application having Ser. No. 61/314,522, filed Mar. 16, 2010, in the name of the same inventor. The above provisional application is herein incorporated by reference.

### FIELD OF THE INVENTION

The present invention relates to prescription medication, and more specifically, to a device, which contains prescription medication, used for accurately and securely monitoring, tracking, recording and dispensing of prescription medication.

### BACKGROUND OF THE INVENTION

Accuracy in the dispensing, monitoring and tracking of prescription medications is a significant medical and health cost concern, as is the timely recording and communicating the administering of medication to the patient. According to the World Health Organization, each year the improper dispensing of prescribed medications results in harm to approximately 1.5 million people. This has led to significant medical costs in treating such harm. For example, in the year 2000 alone, such errors resulted in nearly $1 billion in added medical costs. Also, in the HHS and CMS Report of 2006, it has been stated that over $170 billion was paid out by insurance carriers for unnecessary and or wasted prescription medications in the United States.

Many patients do not comply with proper usage of prescription medications for a variety of reasons. It may be a consequence of a patient knowingly taking medication for which that patient does not have a prescription, and which, for example, may instead have been prescribed to another patient. A patient may inadvertently take too much or too little medication, as a consequence of not clearly understanding the dosing instructions or because of forgetfulness or confusion. Improper usage of prescribed medications can also occur as a consequence of a patient not realizing a risk of a harmful interaction with another medication being taken at the same time by the patient, or by a patient continuing to take a medication without realizing that he or she is experiencing a harmful side effect.

Therefore, a need exists to provide a device and method to overcome the above problems of the prior art.

### SUMMARY

In accordance with one embodiment, an apparatus for the recording and dispensing of medication is disclosed. The apparatus has an electronic device having a screen and a keyboard. A first input device is coupled to the electronic device to send data to the electronic device to verify a particular user of the electronic device. A dispensing device is coupled to the electronic device for dispensing medication to the particular user once the electronic device has verified the particular user.

In accordance with another embodiment of the present invention, an apparatus for the recording and dispensing of medication is disclosed. The apparatus has an electronic device having a screen and a keyboard. The keyboard is used to input personal data about a user and prescription medication data. A biometric input device is coupled to the electronic device to send data to the electronic device to verify the user of the electronic device. A dispensing device is coupled to the electronic device for dispensing medication to the user once the electronic device has verified the user.

The features, functions, and advantages can be achieved independently in various embodiments of the disclosure or may be combined in yet other embodiments. Some embodiments will have minimal feature sets and offer minimal functionality, while others will have substantial features and functionality. Patient need and cost of the electronic device will dictate the number and type of embodiments offered at any given time or in any given circumstance.

### BRIEF DESCRIPTION OF THE DRAWINGS

Embodiments of the disclosure will become more fully understood from the detailed description and the accompanying drawings, wherein:

FIG. 1 is a perspective view of a personalized dispensing apparatus consistent with an embodiment of the present invention;

FIG. 2 is a perspective view of the personalized dispensing system apparatus of FIG. 1, with two “bubbles” or “cavities” housing medications shown in an open position; and

FIG. 3 is a perspective view of a personalized dispensing system consistent with an embodiment of the present invention, illustrating communication between a personalized dispensing apparatus and a server.

Common reference numerals are used throughout the drawings and detailed descriptions to indicate like elements.

### DETAILED DESCRIPTION

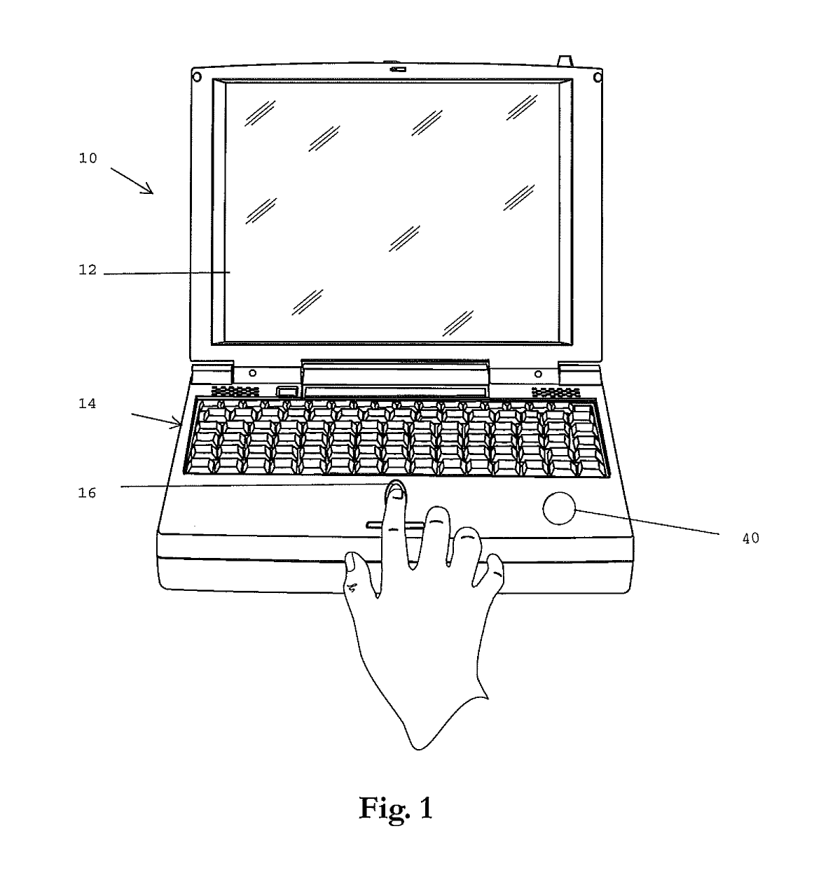

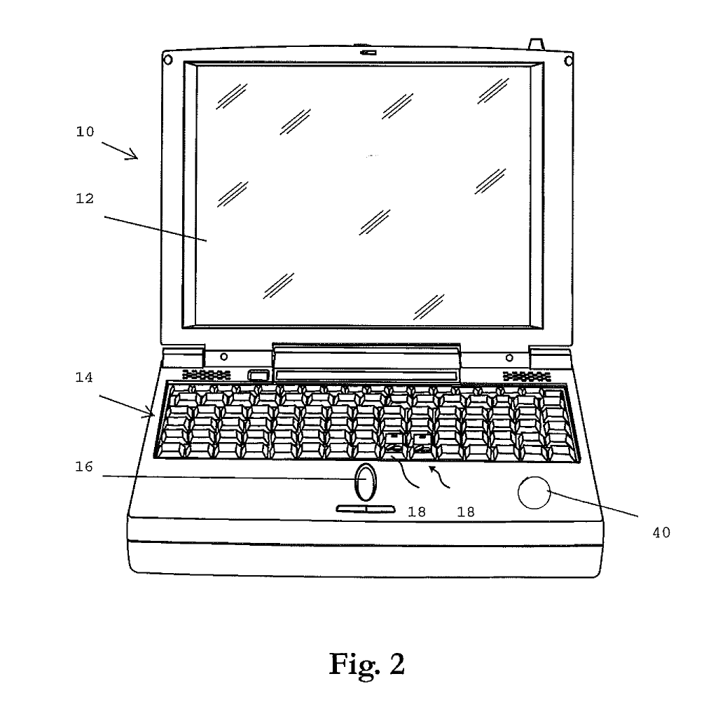

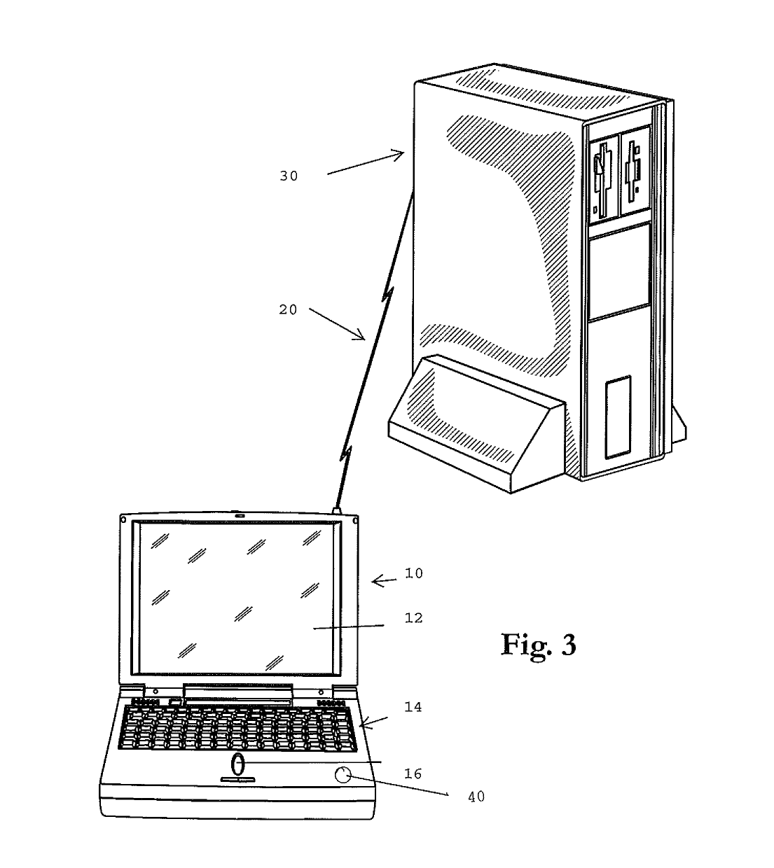

Referring first to FIGS. 1-2, an embodiment of a personalized dispensing apparatus 10 (“apparatus 10”), consistent with an embodiment of the present invention, is shown. In this embodiment, the apparatus 10 has a visual appearance similar to a laptop computer, including a screen 12 and a housing area to contain and dispense medications 14. The apparatus 10 may incorporate computer hardware and software of types known to be associated with prior art laptop computers, enabling a user to receive data or instructions from the apparatus 10, which may be resident in the device or downloaded to the device from a remote server database; thereby, allowing data to be displayed on the screen 12; storing data in internal memory; and allowing the apparatus 10 to in turn upload data over a network or the like with an external device(s), such as a server (see FIG. 3, below).

The apparatus 10 further includes at least one biometric security device and/or other input keypad 16 which, in the embodiment shown in FIGS. 1-2, is a fingerprint recognition pad. Alternatively or in addition, the biometric security device 16 may be an iris scanner, a voice or face recognition device, or the like. In one embodiment, the biometric security device 16 may be an RFID reader or the like, capable of reading a chip located on the user's body (e.g., on a bracelet) or under the user's skin. The goal of the security device 16 is to provide assurance that a person accessing prescribed medication contained within the apparatus 10 has proper authority for doing so, for example because the person has a prescription for that medication or is an authorized health care worker involved in the dispensing of prescription medications to a particular patient for which the dispensed medication is intended.

The apparatus 10 preferably includes at least one and possibly a plurality of bubbles or cavities 18, which are adapted to hold a prescription medication that is to be dispensed. Access to the interior of the bubbles 18 may be controlled by the security device 16, so that only an authorized user may access the interior of the bubbles or cavities 18, as regulated by software resident on the apparatus 10. Access may be permitted for loading the bubbles 18 with a medication to be dispensed, or for dispensing of medication. Upon verification by the apparatus 10, though the security device 16, that a user is authorized, the apparatus 10 may permit an opening/unlocking/unsealing of a bubble or cavity 18. The bubbles or cavities 18 may have the visual aspect of a computer key, as shown by way of example in FIG. 2, or may have a different visual aspect, as desired. The substrate beneath the bubbles may also contain cavities of varying size to accommodate different dosages and/or multiple medications to be administered at the same time.

In another configuration of the apparatus, the bubbles or cavities may be contained in a modular cassette, which would allow for loading and delivery of the medications without transferring the balance of the apparatus hardware. This configuration provides for a patient to remain in control of the apparatus hardware and software, minimizing the chances of damage, misuse and the potential for compromising patient data contained in the apparatus. The separate cassette would be designed to attach to the apparatus hardware when received from the pharmacy or other authorized authority charged with loading the medications into the dispensing device; the cassette would also contain electrical wiring and/or contacts for connecting to and interfacing with the electronic circuitry resident in the device.

Software resident on the apparatus 10 regulates access by a user to bubbles or cavities 18. When the bubbles or cavities 18 are loaded, the user or other authorized person may input into the apparatus 10 information, relating to the particular medication being loaded therein. Such inputting may include dosing information or, alternatively, dosing information generally suitable for a particular medication may be pre-loaded.

At the time of loading, it may further be desired to input into the apparatus 10 information concerning the patient for whom the medication is intended. Such information may include identifying information about the patient, medical history, identity and perhaps contact information for health care provider, insurance information, and the like. In one embodiment, the apparatus 10 may include a card reader or other such device, permitting a health plan card or the like containing relevant health data relating to the patient and contained thereon to be read by the apparatus 10, including for example information regarding the prescribed medication(s) and dosage, thus facilitating a substantially automated entry into the apparatus 10 of the patient's relevant health data and eliminating the need for a pharmacist to enter such information manually. Such card may also be used by the health care worker to gain authorized access to the apparatus. Additionally, this card may be used to create a security match with the biometric data input on the apparatus at the time of access.

In one embodiment, software on the apparatus 10 includes a clock and calendar function that enables the triggering of alerts when a user is required to take a medication located in a bubble or cavity 18. Such an alert may come in the form of an audible sound produced by the apparatus 10, a visual alert displayed on the screen 12, a text message or email generated by the apparatus 10, some combination thereof, or the like. The alert may include, in addition to the reminder to take the medication, information regarding side effects, the name of the prescribing doctor, an image of the medication, and/or other useful information. Upon receiving an alert and/or by reason of matching the date and time information with the biometric input data, a user may then access the medication by activating the security device 16 and triggering an opening of the suitable bubble or cavity 18. In one embodiment, an alert may continue until the apparatus 10 determines that the patient has accessed the medication as described herein.

Upon removal by the user of the medication from the bubble or cavity 18 in response to the alert and the re-closing of the bubble or cavity 18, software resident on the apparatus may record that the requisite dose of the medication was dispensed, and may schedule an alert for the next dose. In one embodiment, a user will not be permitted access to the bubble or cavity 18, even if the user is the patient to whom the stored medication has been prescribed, if it is not yet time for the next dose, so as to prevent over-medication.

In accordance with one embodiment, the apparatus 10 may have an input device 40. The input device 40 may be built into the apparatus 10. Alternatively, the input device 10 may be attached to an I/O port of the apparatus. The I/O port may be may be a USB port, a FireWire port or the like. The listing of the above is given as an example and should not be seen as to limit the scope of the present invention. The input device 40 may be used to check the blood, saliva or the like of the user. Alternatively, the input device may be used to read a biometric chip implanted in the user. Thus, a user may provide a blood, saliva, or the like to the input device 40 or the input device 40 may read a biometric chip or it may accept test data read from another device, such as a blood pressure monitor. The apparatus 10 may be loaded with software to analyze the specimen placed in the input device 40 or read the information from the biometric chip or another input device. The software may analyze whether the user has taken the medication and/or the results of having taken the medication.

As shown by way of example in FIG. 3, the apparatus 10 may be in communication over network 20 with a remote server 30. The remote server 30 may have thereon a centralized database, containing information regarding a plurality of patients, their prescribed medications, their health care providers, and the like. In one embodiment, the apparatus 10 communicates with the remote server 30 and may, for example, query the remote server 30 for updated information regarding potential undesirable interactions with other prescribed medications—including ones prescribed after the patient first received a prescription for the stored medication—or side effects, perhaps taking into account more current information regarding a patient's medical condition. The apparatus 10 may communicate to the remove server 30, for storage in a database located thereon, information regarding the user's dispensing of the prescribed medication. This information may be made accessible to the user's health care provider, insurance provider, pharmacy, clinic, hospital and/or any other individual or entity with authorized access to such patient specific data or to data on a class of patients taking certain medications, whether by allowing the health care provider and/or others referenced above to access the database or by transmitting the data from the server 30 to a computing device (not shown) operated by or on behalf of the provider of such information. In one embodiment, the alert described above may be generated by the remote server 30, transmitted over the network 20, and then displayed at the apparatus 10.

It should be noted that the present invention may have application outside the field of health care, where controlled dispensing of an item only to an authorized recipient may be desired.

While embodiments of the disclosure have been described in terms of various specific embodiments, those skilled in the art will recognize that the embodiments of the disclosure can be practiced with modifications within the spirit and scope of the claims.

What is claimed is:

1. An apparatus for the recording and dispensing of medication comprising:
an electronic device having a screen and a keyboard;
a first input device coupled to the electronic device to send data to the electronic device to verify a particular user of the electronic device; and
a dispensing device coupled to the electronic device for dispensing medication to the particular user once the electronic device has verified the particular user.

2. An apparatus for the recording and dispensing of medication in accordance with claim 1, wherein the first input device is a biometric security device.

3. An apparatus for the recording and dispensing of medication in accordance with claim 1, wherein the first input device is a fingerprint recognition pad.

4. An apparatus for the recording and dispensing of medication in accordance with claim 1, wherein the dispensing device comprises a plurality of locked compartments, wherein each compartment stores a predefined prescription medication of the user.

5. An apparatus for the recording and dispensing of medication in accordance with claim 4, wherein the plurality of locked compartments are integrated as part of the keyboard.

6. An apparatus for the recording and dispensing of medication in accordance with claim 4, wherein the plurality of locked compartments is removable to allow the plurality of locked components to be removed and refilled.

7. An apparatus for the recording and dispensing of medication in accordance with claim 1, wherein the electronic device sends an alert to the user when the user is scheduled to take the medication.

8. An apparatus for the recording and dispensing of medication in accordance with claim 5, wherein the alert is at least one of: an audible alarm, a visual alarm, a text message, an email or a combination thereof.

9. An apparatus for the recording and dispensing of medication in accordance with claim 1, further comprising a second input device coupled to the electronic device, wherein the second input device reads data from the user to verify the user has taken the medication.

10. An apparatus for the recording and dispensing of medication comprising:
an electronic device having a screen and a keyboard, wherein the keyboard is used to input personal data about a user and prescription medication data;
a biometric input device coupled to the electronic device to send data to the electronic device to verify the user of the electronic device; and
a dispensing device coupled to the electronic device for dispensing medication to the user once the electronic device has verified the user.

11. An apparatus for the recording and dispensing of medication in accordance with claim 1, wherein the biometric input device is a fingerprint recognition pad.

12. An apparatus for the recording and dispensing of medication in accordance with claim 10, wherein the dispensing device comprises a plurality of locked compartments, wherein each compartment stores a predefined prescription medication of the user.

13. An apparatus for the recording and dispensing of medication in accordance with claim 12, wherein the plurality of locked compartments are integrated as part of the keyboard.

14. An apparatus for the recording and dispensing of medication in accordance with claim 12, wherein the plurality of locked compartments is removable to allow the plurality of locked components to be removed and refilled.

15. An apparatus for the recording and dispensing of medication in accordance with claim 10, wherein the electronic device sends an alert to the user when the user is scheduled to take the medication.

16. An apparatus for the recording and dispensing of medication in accordance with claim 15, wherein the alert is at least one of: an audible alarm, a visual alarm, a text message, an email or a combination thereof.

17. An apparatus for the recording and dispensing of medication in accordance with claim 10, further comprising a second input device coupled to the electronic device, wherein the second input device reads data from the user to verify the user has taken the medication.

18. An apparatus for the recording and dispensing of medication comprising:
an electronic device having a screen and a keyboard, wherein the keyboard is used to input personal data about a user and prescription medication data;
a biometric input device coupled to the electronic device to send data to the electronic device to verify the user of the electronic device; and
a dispensing device coupled to the electronic device for dispensing medication to the user once the electronic device has verified the user, wherein the dispensing device comprises a plurality of locked compartments, wherein each compartment stores a predefined prescription medication of the user, the plurality of locked compartments integrated as part of the keyboard;
wherein the electronic device sends an alert to the user when the user is scheduled to take the medication.

19. An apparatus for the recording and dispensing of medication in accordance with claim 18, wherein the plurality of locked compartments is removable to allow the plurality of locked components to be removed and refilled.

20. An apparatus for the recording and dispensing of medication in accordance with claim 18, further comprising a second input device coupled to the electronic device, wherein the second input device reads data from the user to verify the user has taken the medication.
